(19) United States
(12) Patent Application Publication
(10) Pub. No.: US 2008/0296374 A1
(43) Pub. Date: Dec. 4, 2008

(54) RECYCLING KIOSK SYSTEM AND METHOD THEREOF

(75) Inventors: RON GONEN, New York, NY (US); Frank C. Yang, Framingham, MA (US); Bob Milligan, Kintersville, PA (US); Scott Lamb, Brerwyn, PA (US)

Correspondence Address: MALDJIAN & FALLON LLC, 365 BROAD ST. , 3RD FLOOR, RED BANK, NJ, 07701, US

(73) Assignee: RecycleBank LLC, Philadelphia, PA (US)

(21) Appl. No.: 12/189,217

(22) Filed: Aug. 11, 2008

Related U.S. Application Data
(63) Continuation-in-part of application No. 11/345,867, filed on Feb. 2, 2006.
(60) Provisional application No. 60/650,610, filed on Feb. 7, 2005.
(60) Provisional application No. 60/954,851, filed on Aug. 9, 2007.

(51) Int. Cl. G06Q 30/00; G06F 19/00

(52) U.S. Cl. 235/385; 705/14

(57) ABSTRACT

Embodiments of the present invention relate to a system and method of providing incentive to recycle recyclable materials by providing financial incentives to consumers for recycling at a recycling kiosk. In one embodiment, a method of providing incentive to recycle recyclable materials comprises providing a recycling kiosk having a load determining device for receiving a quantity of recyclable materials from at least a first entity, obtaining identification data associated with the first entity, measuring the quantity of recyclable material received by the recycling kiosk, calculating a reward based on a measurement of the quantity of recyclable material disposed at least proximate to the recycling kiosk by the at least one entity, and associating the reward to the at least one entity.

### CROSS-REFERENCE TO RELATED APPLICATIONS

This application is a continuation-in-part of U.S. patent application Ser. No. 11/345,867, filed on Feb. 2, 2006, which claims the benefit of U.S. Provisional Patent Application Ser. No. 60/650,610, filed on Feb. 7, 2005, the disclosures of which are incorporated herein by reference in their entireties. This application also claims the benefit of U.S. Provisional Patent Application Ser. No. 60/954,851, filed on Aug. 9, 2007, the disclosure of which is also incorporated herein by reference in its entirety.

### BACKGROUND OF THE INVENTION

1. Field of the Invention

Embodiments of the present invention generally relate to a recycling kiosk and method thereof. More specifically, embodiments of the present invention relate to a system and method of providing incentive to recycle recyclable materials by providing financial incentives to consumers for recycling at a recycling kiosk.

2. Description of the Related Art

Over the past few decades, costs for collecting and disposing waste material (“waste”) have skyrocketed. Decreases in available landfill capacity have caused the cost associated with disposing of waste in such landfills to increase. Adding to these costs are governmental (e.g., federal, state and local) landfill taxes, which have also increased sharply over the past few decades.

Even where landfill capacity exists, the cost associated with potential and actual environmental hazards associated with landfill operation are likewise increasing. These costs can include, for example, losses of valuable property and environmental cleanup costs for rehabilitating landfills and surrounding areas that become contaminated with dangerous chemicals due to the disposal and decomposition of the waste. Given the financial and environmental burdens associated with the collection and disposal of waste, municipalities have actively pursued recycling as an alternative to disposal.

Fortunately, demand for recyclable material has increased as a result of expansion in manufacturing. Manufacturers have long recognized that manufacturing goods from recyclable material less costly than manufacturing such goods from virgin material due to, for example, the costs associated with extracting and processing the virgin material into useable form.

Advances in Single Stream Recycling (SSR) technology reduce the cost of recycling. In addition, recent improvements in automated separation of commingled recyclable material at processing centers have dramatically reduced the cost of collecting, sorting, and processing the recyclable material. The combination of the SSR technology and automated separation enables an automated process to separate and process commingled recyclable material (for example, cardboard, paper, plastic, glass metals, organics, or any reusable material, not desirable for landfills). This combination enables and permits processing centers to cut costs (e.g., reduce labor costs and sorting time) by using an automated process to separate the recyclables as opposed to manual labor. In addition, the combination enables municipalities to cut cost of collection by collecting the recyclable material in commingled form.

While information-technology tools have revolutionized the way many governments and industries operate, the waste management industry has not embraced information technology in the same way. As such, the waste management industry lacks modern, up-to-date information technology tools for efficiently carrying out business management, operations management and other activities associated with recycling (collectively “recycling activities”). In turn, this lack of information-technology tools has limited municipalities and/or other entities administering recycling programs to provide incentives for entities, such as business, governments and households, to recycle; to design effective strategies for recycling; to measure performance against such recycling strategies; etc.

Recycling reduces the financial and environmental burdens of waste disposal, reduces energy costs, and conserves our environment's resources. There is, therefore, a need to establish recycling initiatives which recognize the existing problems associated with the disposal of waste and promote recycling efforts as part of a waste management program.

### SUMMARY OF THE INVENTION

Embodiments of the present invention relate to a system and method of providing incentive to recycle recyclable materials by providing financial incentives to consumers for recycling at a recycling kiosk. In one embodiment, a method of providing incentive to recycle recyclable materials comprises providing a recycling kiosk having a load determining device for receiving a quantity of recyclable materials from at least a first entity, obtaining identification data associated with the first entity, measuring the quantity of recyclable material received by the recycling kiosk, calculating a reward based on a measurement of the quantity of recyclable material disposed at least proximate to the recycling kiosk by the at least one entity, and associating the reward to the at least one entity.

In another embodiment, a method of recycling using a recycling kiosk, the method comprises providing a recycling kiosk having a load determining device for receiving a quantity of recyclable materials from at least a first entity, obtaining identification data associated with the first entity, weighing the quantity of recyclable material received by the recycling kiosk, transmitting the identification data associated with the first entity and a weight of the quantity of recyclable material to a remote database via a computer network, calculating a reward based on the weight of the quantity of recyclable material disposed at least proximate to the recycling kiosk by the at least one entity, and associating the reward to the at least one entity.

In yet another embodiment, a recycling kiosk comprises a platform for receiving a quantity of recyclable materials, a load determining device for measuring the quantity of recyclable materials received on the platform, a data acquisition unit for obtaining identification data associated with at least a first entity, a network connection means for connecting to a remote database, a reward calculation means, and a graphical user interface.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawing. It is to be noted, however, the appended drawing illustrates only typical embodiments of embodiments encompassed within the scope of the present invention, and, therefore, is not to be considered limiting, for the present invention may admit to other equally effective embodiments, wherein:

FIG. 1 is an illustration of a block diagram of a general computer system in accordance with one embodiment of the present invention.

FIG. 2 is an illustration of an example of a flow for recycling recyclable material in accordance with one embodiment of the present invention.

FIG. 3 is an illustration of a recycling kiosk in accordance with one embodiment of the present invention.

FIG. 4 is a flow diagram illustrating the method of recycling using a recycling kiosk, in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, components and circuits have not been described in detail, so as to not obscure the following description. Further, these examples disclosed are for exemplary purposes only and other examples may be employed in lieu of, or in combination with, the examples disclosed.

Overview

Embodiments of the present invention generally relate to a recycling kiosk and method thereof. More specifically, embodiments of the present invention relate to a system and method of providing incentive to recycle recyclable materials by providing financial incentives to consumers for recycling at a recycling kiosk.

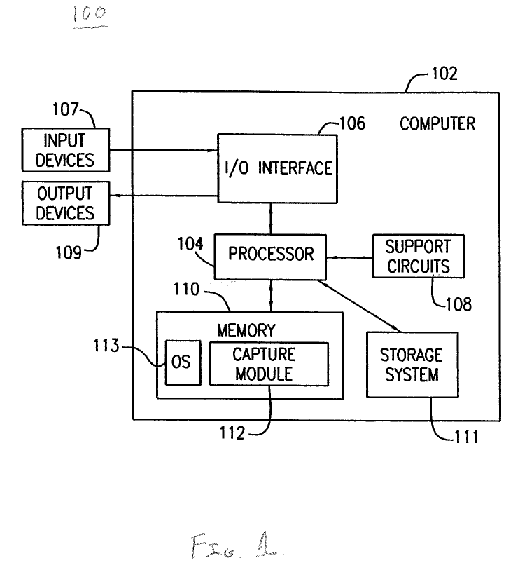

FIG. 1 is an illustration of a block diagram of a general computer system in accordance with one embodiment of the present invention. The computer system 100 generally comprises a computer 102. The computer 102 illustratively comprises a processor 104, a memory 110, various support circuits 108, and I/O interface 106, and a storage system 111. The processor 104 may include one or more microprocessors. The support circuits 108 for the processor 104 include conventional cache, power supplies, clock circuits, data registers, I/O interfaces, and the like. The I/O interface 106 may be directly coupled to the memory 110 or coupled through the processor 104. The I/O interface 106 may also be configured for communication with input devices 107 and/or output devices 109, such as network devices, various storage devices, mouse, keyboard, display, and the like. The storage system 111 may comprise any type of block-based storage device or devices, such as a disk drive system.

The memory 110 stores processor-executable instructions and data that may be executed by and used by the processor 104. These processor-executable instructions may comprise hardware, firmware, software, and the like, or some combination thereof. Modules having processor-executable instructions that are stored in the memory 110 may include a capture module 112. The computer 102 may be programmed with an operating system 113, which may include OS/2, Java Virtual Machine, Linux, Solaris, Unix, HPUX, AIX, Windows, MacOS, among other platforms. At least a portion of the operating system 113 may be stored in the memory 110. The memory 110 may include one or more of the following: random access memory, read only memory, magneto-resistive read/write memory, optical read/write memory, cache memory, magnetic read/write memory, and the like.

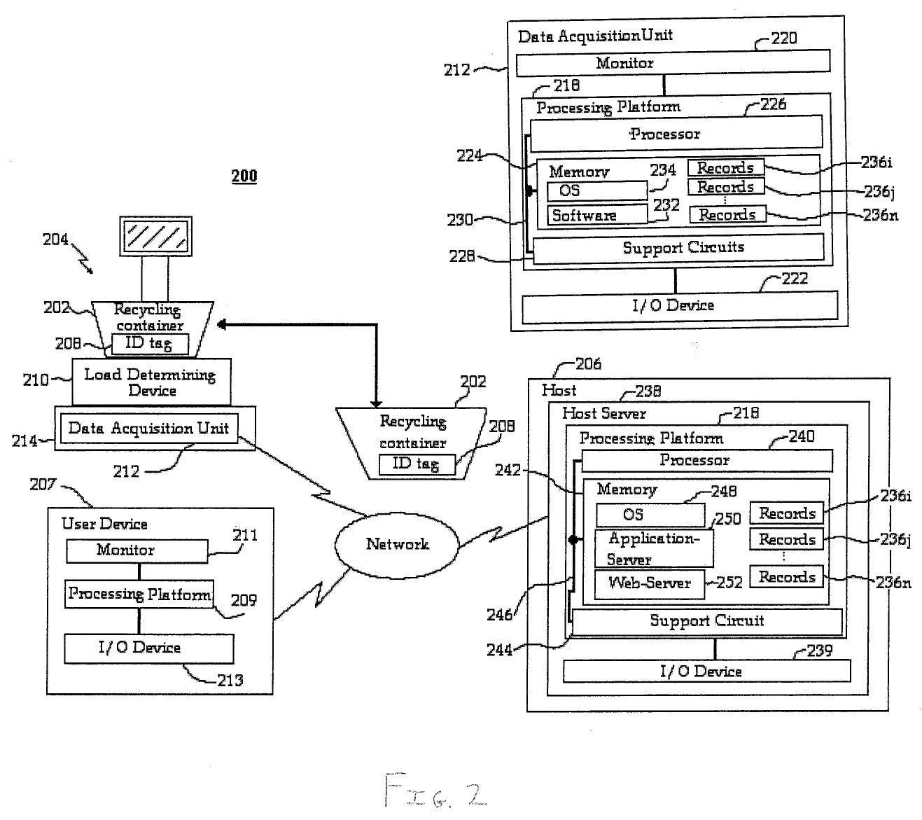

FIG. 2 is an illustration of an example of a flow for recycling recyclable material 200 in accordance with one embodiment of the present invention. The system includes recycling container 202, a kiosk 204, a host 206 and a user device 207.

The recycling container 202 is adapted to accept recyclable material deposited by an entity (“deposited material”) for collection in the kiosk 204. The deposited material may include one type of or any combination of types of recyclable material, including, for example, cardboard, paper, plastic, glass and/or aluminum material. The recycling container 202 may be of any shape or size so long as it is adapted to hold a quantifiable measure of the deposited material. The recycling container 202 may be provided to an entity for a fee (e.g., a one-time, fixed, rental, deposit, or other type of fee) or for free (e.g., on loan or given outright).

The recycling container 202 includes an identification tag 208 for identifying the recycling container 202. The identification tag 208 may be used to track each collection of the deposited material. The identification tag 208 may be machine-readable device, such as a bar-code label, a magnetic-strip device, a radio-frequency-identification (“RFID”) tag and the like; and may include and/or be programmed with information for identifying the recycling container 202, and in turn, information (e.g., an address, an account, etc.) associated with the entity.

The identification tag 208 may also be a non-machine readable label or other non-machine readable device. As such, the identification tag 208 may include an identifier that can be transferred to (e.g., manually entered into) the host 206, which in turn, uses the identifier to obtain information stored thereon for identifying the recycling container 202 and the entity information.

The kiosk 204 may be an interactive terminal adapted to receive the recyclable materials from the recycling container 202. The kiosk 204 may include a load determining device 210 and a data acquisition unit 212. The load determining device 210 may include any of, any multiple of, any combination of or any combination of multiples of a scale, load cell, load-cell system, a counting device and/or system or other measuring apparatus or system for (i) determining a quantifiable measure (e.g., weight, quantity, etc.) of the deposited material and/or (ii) transferring such quantifiable measure (“deposited-material measure”) to the data-acquisition unit 212 for storage and/or subsequent processing. The load determining device 210 may, for example, determine the deposited-material measure as a function of a plurality of weight measurements of the recycling container 202 obtained before and after the deposited material are transferred to the kiosk 204.

The load determining device 210 may also determine the deposited-material measure as a function of quantities of the deposited material in recycling container 202 before and after such material are transferred to the kiosk 204. The load determining device 210 may determine the deposited-material measure in other ways as well.

Some or the entire load determining device 210 may be coupled (e.g., affixed or removably attached) to the kiosk 204. For example, all or portions of the load determining device 210 may be coupled to a base 214 of the kiosk 204. Also, all or portions of the load determining device 210 may be removably attached to the kiosk 204 for efficient transport or storage of the kiosk 204.

The data-acquisition unit 212 and host 206 may communicatively coupled together via a link or network (collectively “network”) 216. This way, the data-acquisition unit 212 and host 206 may exchange information via one or more communications carried over the network 216.

The network 216 may be a partial or full deployment of most any communication or computer network or link, including any of, any multiple of, any combination of or any combination of multiples of a public or private, terrestrial wireless or satellite, and wireline networks or links. The network 216 may include, for example, network elements from a Public Switch Telephone Network (“PSTN”), the Internet, core and proprietary public networks, wireless voice and packet-data networks, such as 1G, 2G, 2.5G and 3G telecommunication networks, wireless office telephone systems (“WOTS”) and/or wireless local area networks (“WLANs”), including, Bluetooth and/or IEEE 802.11 WLANs, wireless personal area networks (“WPANs”), wireless metropolitan area networks (“WMANs”) and the like; and/or communication links, such as Universal Serial Bus (“USB”) links; parallel port links, Firewire links, RS-232 links, RS-485 links, Controller-Area Network (“CAN”) links, and the like.

The network elements and/or communication links may include circuit-switched as well as packet-data elements to provide transport of content, triggers and/or other information; and may be configured to communicate such information using any number of protocols and in any manner consistent with exchanging such information among data-acquisition unit 212 and host 206. These protocols may include standardized, proprietary, open-source, and freely-available communication protocols for communicating content in circuit-switching and/or packet data networks, and the like.

The data acquisition unit 212 may be, for example, any of or any combination of a personal computer; a portable computer, a handheld computer; a mobile phone, a digital assistant, a personal digital assistant, a cellular phone, a smart phone, a pager, a digital tablet, a laptop computer, an Internet appliance and the like. In general, the data acquisition unit 212 includes a processor-based platform that operates on any suitable operating system, such as Microsoft® Windows®, Linux and/or Symbian; and that is capable of executing software.

Additionally, the data acquisition unit 212 may be formed in a single unitary device and concentrated on a single server, client, peer or other type node. Alternatively, the data acquisition unit 212 may be formed from one or more separate devices, and as such, may be distributed among a number of server, client, peer or other type nodes. The data acquisition unit 212 may also be scalable (i.e., may employ scale-up and/or scale-out approaches).

The data acquisition unit 212 may include a large number of elements; most of which are not shown in FIG. 1 for simplicity of exposition. As shown, the data acquisition unit 212 includes a processing platform 218 that is operable to control, manipulate or otherwise interact with a monitor 220 or other display device (collectively “monitor”) and/or an input/output (“I/O”) device 222, via respective couplings.

The monitor 220 may be any suitable device that displays viewable images and/or text generated by the processing platform 218. For instance, the monitor 220 may be any of or any combination of a liquid-crystal-display based monitor, a cathode ray tube monitor, a plasma display monitor, a surface-conduction electron-emitter display monitor, an organic light-emitting diode display monitor, or any other monitor that can display viewable images using television and/or computer protocols, such as Super Video Graphics Array, Digital Visual Interface, Phase Alternating Line, SECAM, NTSC, etc.

The I/O device 222 may be any device that accepts input from a user (man or machine) to control, manipulate or otherwise interact with the operation of the processing platform 218. In addition, the I/O device 222 may be adapted to obtain from the identification tag 208 the entity information and/or identifier that identifies the recycling container 202. Examples of the I/O device 220 include any of or any combination of pointing device, such as a mouse, joystick, trackball, touchpad, pointing stick, light pen, head pointer, soap mouse, eye tracking devices, digitizing tablet and stylus, data glove that translates the user's movements to computer gestures; and a key-in device, such as a keyboard or a touchpad; a reader, such as a bar-code reader, a magnetic-strip reader, a RFID reader, voice recognition devices, and the like. Although shown as a single device, the I/O device 222 may be separated into two or more devices; each of which may have, as compared to the I/O device 222, reduced, increased or equivalent functionality. In addition, the I/O device 222 and the monitor 220 may be integrated or otherwise combined together in a single device and/or housing.

The processing platform 218 includes memory 224, one or more processors (collectively “processor”) 226, supports circuits 228 and bus 230. The memory 224 may be or employ random access memory, read-only memory, optical storage, magnetic storage, removable storage, erasable programmable read only memory and variations thereof, content addressable memory and variations thereof, flash memory, disk drive storage, removable storage, any combination thereof, and the like.

The memory 224 may store and/or receive requests from the processor 226 to execute software 232, such as operating system 234. Additionally, the memory 224 may store and/or receive requests from the processor 226 to obtain (i) operands, operators, dimensional values, configurations, and other data that are used by the operating system 234 and the software 232 to control the operation of and/or to facilitate performing the functions of the data acquisition unit 212; and/or (ii) one or more records or other data structures (collectively, “records”) 236.sub.i-236.sub.n.

Each of the records 236.sub.i-236.sub.n may be stored as or in a single file or a plurality of files, and may be structured as text, a table, a database, a distributed hashtable, a distributed concurrent object store, a document formed using a markup or markup-like language, and the like. The records 236.sub.i-236.sub.n may include, for example, a deposited-material record 236.sub.j. The deposited-material record 236.sub.j may store, be populated with or otherwise adapted to hold the deposited-material measure as determined by the load determining device 210.

The processor 226 may execute (e.g., launch, generate, run, maintain, etc.) and/or operate on the operating system (“OS”) 234. The processor 226 may be capable of (i) executing the software 232; (ii) storing the records 236.sub.i-236.sub.n in the memory 224; (iii) dispatching to the host 206 the records 236.sub.i-236.sub.n (including the deposited-material record 236.sub.j) for further processing; (iv) issuing triggers and/or (v) issuing one or more commands and/or instructions to cause the further processing of records 236.sub.i-236.sub.n. Examples of the processor 226 include conventional processors, microprocessors, multi-core processors, microcontrollers and the like.

The support circuits 228 facilitate operation of the processor 226 and may include well-known circuitry or circuits, including, for example, an I/O interface; one or more network-interface units (“NIUs”); cache; clock circuits; power supplies; and the like. The NIUs may be adapted for communicating over any of, any multiple of, any combination of or any combination of multiples of terrestrial wireless, satellite, and/or wireline media. The processor 226 (and in turn, the data-acquisition unit 212) may use the NIUs for exchanging content with the host 206 via network 216.

The bus 230 provides for transmissions of digital information among the processor 226, the memory 224, support circuits 228 and other portions of the data acquisition unit 212 (shown and not shown). The I/O interface is adapted to control transmissions of digital information between (shown and not shown) components of the data acquisition unit 212. In addition, the I/O interface is adapted to control transmissions of digital information between I/O devices disposed within, associated with or otherwise attached to the data acquisition unit 212. Examples of the I/O devices include the I/O device 222, the monitor 220, and any or any combination of (i) storage devices, including but not limited to, a tape drive, a floppy drive, a hard disk drive or a compact disk drive, (ii) a receiver, (ii) a transmitter, (iii) a speaker, (iv) a display, (v) a speech synthesizer, (vi) an output port, and (vii) the like.

The operating system 234 may include code for operating the data acquisition unit 212 and for providing a platform onto which the software 232 can be executed. The software 232 may include data-acquisition software, which may carry out the acquisition of and storage of the deposited-material measure into the deposited-material record 236.sub.j. The data-acquisition software may also communicate the deposited-material record 236.sub.j to the host 206 using, for example, the communication and/or security protocols compatible with the data acquisition unit 212 and the host 206. To facilitate this, the data-acquisition software may include code to allow the data-acquisition software (and/or the data acquisition unit 212) to substantiate its identity, and in turn, receive authorization to access (e.g., view, configure, use and/or execute) services of the host 206.

The host 206 may include one or more servers, including a host server 238. The host server 238 may be deployed in one or more general or specialty purpose computers, personal computers, mainframes, minicomputers, server-type computers and/or any a processor-based platform that operates on any suitable operating system, such as Microsoft® Windows® and/or Linux; and that is capable of executing software.

Like the data acquisition unit 212, the host server 238 may include a large number of elements; most of which are not shown in FIG. 1 for simplicity of exposition. The elements of host server 238 may be formed in a single unitary device and concentrated on a single server, client, peer or other type node. Alternatively, the elements of the host server 238 may be formed from two or more separate devices, and as such, may be distributed among a number of server, client, peer or other type nodes.

The host server 238 may be deployed in accordance with the scale-up and/or scale-out approaches. Using the scale-up approach, the host server 238 may increase its processing power, amount of memory and number of networkable connections by utilizing a symmetrical, multi-processor architecture so as to provide additional capacity. A benefit of this scale-up approach is that such approach provides for simplified configuration and management as compared to the scale-out approach. Using the scale-out approach, the host server 238 may increase its processing power, amount of memory and number of networkable connections by incrementally adding and/or removing capacity as needed, balancing workload across multiple processors, multiple servers, dedicating specific processors and/or servers for performing specific tasks, using physical or logical servers (e.g., a multi-node cluster approach), etc.

As shown, the host server 238 includes one or more processing units (collectively “processor”) 240, memory 242, supports circuits 244 and bus 246. The processor 240 may be one or more conventional processors, microprocessors, multi-core processors, microcontrollers and the like.

The bus 246 provides for transmissions of digital information among the processor 240, memory 242 and support circuits 244 and other (not shown) portions of the host server 238. The support circuits 244 facilitate operation of the processor 240, and may include well-known circuitry or circuits, including, for example, one or more input/output I/O interfaces; one or more NIUs; cache; clock circuits; power supplies and the like.

The I/O interface provides an interface to control the transmissions of digital information among (shown and not shown) components of host server 238. In addition, the I/O interface provides an interface to control the transmissions of digital information among I/O devices 239 associated with or otherwise attached to the host server 238. The I/O devices 239 may be embodied as any or any combination of (i) storage devices, including but not limited to, a tape drive, a floppy drive, a hard disk drive or a compact disk drive, (ii) a receiver, (ii) a transmitter, (iii) a speaker, (iv) a display, (v) a speech synthesizer, (vi) an output port, and (vii) a pointing device, such as a mouse, joystick, trackball, touchpad, pointing stick, light pen, head pointer, soap mouse, eye tracking devices, digitizing tablet and stylus, data glove that translates the user's movements to computer gestures; (vii) a key-in device, such as a keyboard or a touchpad, (viii) and the like.

The NIUs facilitate exchange (e.g., sending and/or receiving) of content. Accordingly, the NIUs may be adapted for communicating over terrestrial wireless, satellite, and/or wireline media.

The memory 242 may be or employ random access memory, read-only memory, optical storage, magnetic storage, removable storage, erasable programmable read only memory and variations thereof, content addressable memory and variations thereof, flash memory, disk drive storage, removable storage, any combination thereof, and the like. The memory 224 may store and/or receive requests from the processor 240 to execute various software packages, such as operating system 248, application-server software 250 and web-server software 252.

Additionally, the memory 242 may store and/or receive requests from the processor 240 to obtain the records 236.sub.i-236.sub.n (e.g., copies thereof). As above, each of the records 236.sub.i-236.sub.n may be stored as or in a single file or a plurality of files, and may be structured as text, a table, a database, a distributed hashtable, a distributed concurrent object store, a document formed using a markup or markup-like language, and the like. The records 236.sub.i-236.sub.n may be stored, for example, using a Microsoft SQL Server and accessible through an ODBC connection.

Like the records 236.sub.i-236.sub.n, the memory 242 may store and/or receive requests from the processor 240 to obtain operands, operators, dimensional values, configurations, and other data that are used by the various software packages to control the operation of and/or to facilitate performing the functions of the host server 238 and/or the host 206.

The application-server software 250, when executed by the processor 240, is operable to (i) communicate with the data acquisition unit 212, via the network 216, to obtain the deposited-material record 236.sub.j; and determine a value associated with the deposited-material measure stored in the deposited-material record 236.sub.j. In addition, the application-server software 250, when executed by the processor 240, is operable to associate the value to a credit, which may be redeemable by the entity; post the credit to the credit to a user account associated with the entity (“entity account”); and provide the web-server software 252 with access to the entity account.

The web-server software 252, when executed by the processor 240, is operable provide on one or more web pages to allow the entity to access the entity account, and in turn, the credit and other information associated with the recycling activities. For example, web-server software 252 may post the credit on the web pages that are accessible to entity via the user device 207 and entity account, so as to enable the entity to view details of the entity account. The details of the entity account may include the credit (and/or previously accrued credits) associated with the recycling activities of the deposited (and/or previously deposited) material, dates associated with the recycling activities, quantities of the deposited and (previously deposited) material recycled over a given period of time; debits from the credit (and/or previously accrued credits), detailed history of spending of the credit (and/or previously accrued credits), any orders for vouchers for redeemed credits, and the like.

In addition, the web-server software 252, when executed by the processor 240, is operable to allow the entity, via the user device 207, to redeem the credit. This may include the web-server software 252 providing a portal to retailers to allow the entity to redeem the credit (and/or previously accrued credits) at the retailers to obtain goods, services, coupons valued for goods or services, other benefits or discounts, and the like.

The web-server software 252 may also be operable to allow the entity to transform the credit (and/or previously accrued credits) into one or more vouchers that may be spent at the participating retailers or donated to some other entity. To facilitate this, the web-server software 252 includes code to allow the entity to (i) order the vouchers for delivery by mail, email or other communication medium; (i) provide information to the entity via the user device 207 to allow the entity to print or otherwise reduce to physical form, store it on the user device 207 or a peripheral device coupled to the user device 207 (e.g., a PDA, memory device, etc.).

The user device 207 may be, for example, any of or any combination of a personal computer; a portable computer, a handheld computer; a mobile phone, a digital assistant, a personal digital assistant, a cellular phone, a smart phone, a pager, a digital tablet, a laptop computer, an Internet appliance and the like. In general, the user device 207 may include a processor-based platform that operates on any suitable operating system, such as Microsoft® Windows®, Linux and/or Symbian; and that is capable of executing software.

The user device 207 may, however, include a large number of elements; many of which are not shown in FIG. 1 for simplicity of exposition. The user device 207 includes elements similar to the data acquisition unit 212, except as described herein below. The user device 207 may be formed in a single unitary device and concentrated on a single server, client, peer or other type node. Alternatively, the user device 207 may be formed from one or more separate devices, and as such, may be distributed among a number of server, client, peer or other type nodes. In addition, the user device 207 may be scalable.

As shown, the user device 207 may include a processing platform 209 that is operable to control, manipulate or otherwise interact with a monitor 211 and/or an I/O device 213, via respective couplings. The processing platform 209, the monitor 211 and the I/O device 213 include elements similar to or the same as the processing platform 218, the monitor 220 and the I/O device 222 of the data acquisition unit 212, and as such, the details of such elements are not reproduced here for simplicity of exposition.

The user device 207 is operable to form a user interface through which the entity can access the web pages provided by the web-server software 252. To facilitate this, the user interface may be communicatively coupled with the host server 238 via a network 216. The user interface may be, for example, a graphical-user interface that is operable execute a web browser application for rendering on the monitor 211 the web pages provided by the web-server software 252. As noted, the entity may use the user device 207 to access the users account, redeem credits and other like functions.

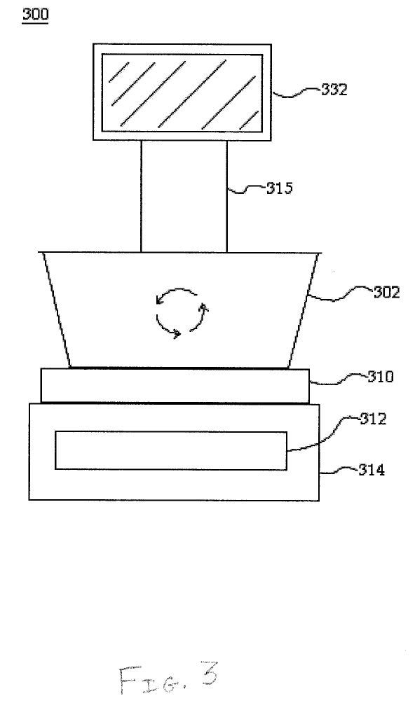

FIG. 3 is an illustration of a recycling kiosk 300 in accordance with one embodiment of the present invention. The recycling kiosk 300 generally includes a base portion 314, a stand portion 315, a load determining device 310, a data acquisition device 312 and a graphical interface 332. Optionally, a recycling container 302 may be included with the recycling kiosk 300.

Generally, the base portion 314 may support the other components of the recycling kiosk 300. As the recycling kiosk 300 may be moved or transported from one location to another, the base portion 314 may optionally include wheels, casters, or a like mechanism that aids in an efficient transportation of the recycling kiosk 300. The stand portion 315, which may also be characterized as a pedestal, support column, or the like, may be supported by the base portion 314. Generally, a proximate end of the stand portion 315 may be coupled (e.g., affixed or removably attached) to the base portion 314 and a distal end of the stand portion 315 may rise substantially vertically from the base portion 314.

A load determining device 310 and a data acquisition unit 312 may also be included in the recycling kiosk 300. A portion of the load determining device 310 or the entire load determining device 310 may be coupled (e.g., affixed or removably attached) to the recycling kiosk 300. For example, in accordance with one embodiment of the present invention, the entire load determining device 310 is coupled to the base portion 314 of the recycling kiosk 304, such that a force placed on a top surface, or platform, of the load determining device 310 (e.g., due to the weight of recyclable material) is transferred to the base portion 314. Additionally, all or portions of the load determining device 310 may be removably attached to the recycling kiosk 304 for efficient transport or storage of the recycling kiosk 304, the use of which remains within the scope of the present invention.

The data acquisition unit 312 may be a computerized device or combination thereof, as discussed with reference to FIG. 2. The data acquisition unit 312 may be located within the recycling kiosk 300. In accordance to one embodiment of the present invention, the data acquisition unit 312 is located within the base portion 314 of the recycling kiosk 300. However, the data acquisition unit 312 may also be located within any portion of the recycling kiosk 300. Further, the data acquisition unit 312 may be, partially or entirely, remotely located from the recycling kiosk 300

The load determining device 310 may include any of, any multiple of, any combination of or any combination of multiples of a scale, load cell, load-cell system, a counting device and/or system or other measuring apparatus or system for (i) determining a quantifiable measure (e.g., weight, quantity, etc.) of the deposited material and/or (ii) transferring a deposited-material measure to the data-acquisition unit 312 for storage and/or subsequent processing.

A recycling container 302 may be included with the recycling kiosk 300. The recycling container 302 may be any container, capsule, structure, or the like, capable of holding a recyclable material. Generally, the recycling container 302 may be removably disposed on the load determining device 310. However, the recycling kiosk 300 may also include other structures, components, or entities to store, support or house the recycling container 302, the use of which remains within the scope of the present invention.

The recycling kiosk 300 may also include a graphical interface 332. The graphical interface 332 may be any of, or any combination of, a liquid-crystal-display based display, a cathode ray tube display, a plasma display, a surface-conduction electron-emitter display, an organic light-emitting diode display, or any other display device that can display viewable images using television and/or computer protocols, such as Super Video Graphics Array, Digital Visual Interface, Phase Alternating Line, SECAM, NTSC, etc. Additionally, the graphical interface 332 may include an interactive component to interact with an entity using the recycling kiosk 300.

In accordance with one embodiment of the present invention, the graphical interface 332 may be supported by the stand portion 315. The graphical interface 332 may generally be located at convenient height for an entity using the recycling kiosk 300. Optionally, the graphical interface 332 may be located, partially or entirely, at a remote location from the recycling kiosk 300.

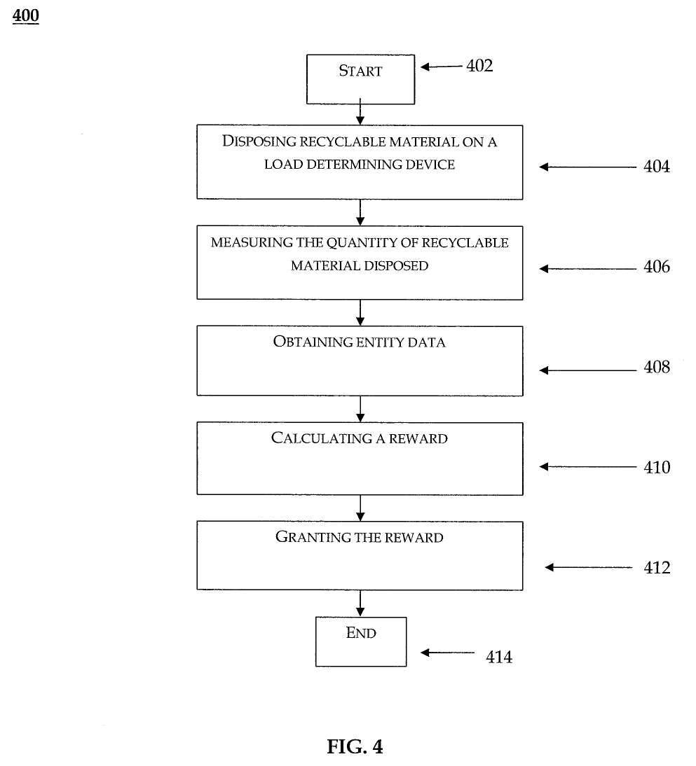

FIG. 4 is a flow diagram illustrating the method of recycling using a recycling kiosk system 400, in accordance with one embodiment of the present invention. For convenience, the flow diagram 400 is described with reference to the recycling kiosk 300 of FIG. 3. The flow diagram 400, however, may be carried out using other architectures as well.

It should be noted that any process descriptions or blocks in flow diagrams should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

The method of recycling using a recycling kiosk 400 starts at start block 402. At diagram block 404, a quantity of recyclable material is deposited by at least one entity. The entity may deposit the quantity of recyclable material to a location that is at least proximate to a recycling kiosk 300. In one embodiment of the present invention, the quantity of recyclable material is deposited on a load determining device 310.

The deposited material may be contained within a recycling container 302 for convenience. The recycling container 302 may be a standard recycling container or a customized recycling container uniquely designed to be compatible with the recycling kiosk 300. The deposited material within the recycling container 303 may include a homogeneous composition of material, such as only metals, only plastics, or only papers, etc. Alternatively, the deposited material within the recycling container 302 may include a mixed composition of recyclable materials. Additionally, the deposited material may also include non-recyclable material, such as residue left within a recyclable materials or labeling materials, such as paper or plastic wrappers.

The entity or user of the recycling kiosk 300 may place the recycling container 302 containing recyclable material on the load determining device 310. In one of many alternative embodiments, an entity may deposit individual recyclable materials (e.g., individual cans, bottles, etc.) in a chute that directs the deposited materials to a load determining device 310.

At diagram block 406, the recyclable material disposed proximate to the kiosk 300 is measured with the load determining device 310. In one embodiment, the load determining device 310 may determine the deposited material as a function of a plurality of weight measurements of the recycling container 302 obtained before and after the deposited material is transferred to a storage container of the kiosk 300. Alternatively, the load determining device 310 may, for example, determine the quantity of recyclable material disposed as a function of a plurality of measurements of quantities of the recyclable material in recycling container 302 obtained before and after such material is transferred to the kiosk 300.

Although, generally, the load determining device may measure the weight of a quantity of recyclable materials, the load determining device 310 may determine a deposited-material measure in other ways as well, such as by volume, mass, quantity, and the like.

At diagram block 408 entity data is obtained. In one embodiment, the entity data obtained may be associated with at least one entity, such as one user of the recycling kiosk, one account associated with the recycling kiosk, or the like. However, alternative embodiments may include obtaining entity data from a plurality of entities, such as, for example, an organization with a plurality of employees.

Entity data may be obtained through a number of ways. In one embodiment, entity data is obtained by a data acquisition unit 312, adapted to identify an entity. For example, an entity using a recycling kiosk 300, may be identified by reading or sensing an identification characteristic on a recycling container 302 disposed by the entity.

For example, the recycling container 302 may include a specific radio frequency signal (RFID) tag which is read by a RFID reader of the data acquisition unit 312. In this embodiment, the RFID reader may identify the RFID tag of a particular recycling container 302 and associate that RFID tag with a corresponding entity. In a second example, the data acquisition unit 312 may include a barcode reader that reads a barcode located on a recycling container 302 and associate that barcode with a corresponding entity.

Entity data may also be obtained by receiving information directly, or substantially directly, from an entity. For example, a data acquisition unit 312 on the recycling kiosk 300 may include a keypad or input device in which an entity may enter a number or code that corresponds to the identity of the entity. The number or code may include a phone number, a personal identification number (PIN) or other number or sequence of characters specific to the entity's identity. The data acquisition unit 312 may also include a card reader, in which an entity is identified when a credit card or other card corresponding to the entity's identity is swiped in the card reader. Other methods of obtaining entity data may also be used within the method of recycling using a recycling kiosk 400, the use of which remains within the scope of the present invention.

In one embodiment of the present invention, entity data obtained may include data relating to the deposited-material measure. For example, the data acquisition unit 312 may obtain a deposited-material measure from the material disposed in the recycling container 302. To facilitate this, the recycling container 302 may be positioned or otherwise placed on the load determining device 310. The load determining device 310 may receive a trigger, command or other input to cause the load determining device 310 to take a measurement. Data associated with this measurement may be transmitted to the data acquisition unit 312. Other methods or systems of carrying this out may also be used, the use of which remains within the scope of the present invention.

Entity data obtained may be provided to an entity through the graphical interface 332. In general, entity data provided via the graphical interface 332 may include information relevant to the deposited-material measure, the type or class of the deposited material, information corresponding to the identity of the entity or any other information relevant to a transaction with the recycling kiosk 300 or the method of recycling using a recycling kiosk 400. This may also include an entity's current balance of rewards (i.e., account status), or a list of local redemption partners.

Additionally, advertisements or messages may be provided to an entity while using a recycling kiosk 300. These advertisements or messages may be displayed on the graphical interface 332, permanently displayed on the recycling kiosk 300, or a combination thereof. Advertising/message space or time may be licensed to a third party company to display a brand name, trademark, advertising statement, pertinent message regarding the use of the recycling kiosk, or any public/private statement.

At diagram block 410 a reward is calculated. In one embodiment, the reward calculated (“calculated reward”) is based on a deposited-material measure, which may generally correspond to a measurement from the load determining device 310. Additionally, in one embodiment, the reward may be calculated based on the weight of recyclable material, where the deposited-material measure may be entered into an algorithm in order to determine the calculated reward.

In another embodiment, the reward may be calculated by transmitting a deposited-material measure from the load determining device 310 of the recycling kiosk 300 to a processing center. The transmission of the deposited-material measure from the load determining device 310 may be generally characterized as transmitting a signal. Additionally, a plurality of signals may also be utilized. The signal may be received by the processing center, wherein a reward is calculated based on the aforementioned methods, including a translation of the signal into a numerical weight value to calculate the award. A second signal may also be transmitted from the processing center to the recycling kiosk 300 or a component thereof, with information associated with the calculated reward. The signals transmitted and received may be transmitted via a global network connection or other network connection.

In one embodiment of the present invention, the calculated reward, information associated with the deposited-material measure, or entity data, may be recorded in a database. The database may be integral, separate, in communication with, or a combination thereof with the processing center. The database may also be in communication with the recycling kiosk 300 or a component thereof.

Recording information in a database may offer many benefits in the method of recycling using a recycling kiosk 400. Specifically, information unique to the transaction, such as the account number of an entity, the deposited-material measure, and/or the amount of rewards granted, may be recorded in the database in order to keep track of the activity of the recycling kiosk 300 and to credit the proper entity accounts.

At diagram block 412, a reward is granted. In one embodiment, the entire calculated reward may be granted to an entity, however, other embodiments may include granting a portion of the calculated reward while retaining a portion of the calculated reward. Further, the calculated reward, or a portion thereof, may be granted to one entity or a plurality of entities.

The calculated reward granted may be a direct monetary reward, such as cash dispensed from the recycling kiosk 300. The reward may also be granted using a system of points, having a redeemable value, wherein an entity may accrue points in an account and redeem the points for goods or services at a later time or at a different location. This system of points may include the issuance of gift certificates, or the granting of monetary value to an entity's account.

In accordance with one embodiment of the present invention, the recycling kiosk may allow multiple transactions per time period (e.g., a day or week) with a single entity. The recycling kiosk may also include a mechanism to issue a date/time stamp for each transaction, and may optionally print out a receipt for an entity.

Prior to a reward being granted, an entity may generally surrender at least a portion of the recyclable material to the recycling kiosk 300. The quantity of materials surrendered may substantially correspond to the reward granted. Surrendering the recyclable materials may generally include placing the recyclable materials into one or more storage containers associated with the recycling kiosk 300.

The storage containers may include large receptacles with an opening, or a plurality of openings. In many embodiments the storage containers have a fraud detection or prevention device, such as a lockable door or other device to prevent removal of any recyclable material from the storage container, such that any efforts to extract material from the storage container would be severely impeded once the recyclable material has been surrendered. In accordance with some embodiments, the storage container may further comprise a compactor for minimizing volume of the recyclable materials within the storage container.

In accordance with one embodiment of the present invention, a fraud detection system and method thereof is provided with the recycling kiosk. The fraud detection system may include a video surveillance system, which may further include a video surveillance analysis system to identify a user who incorrectly uses the recycling kiosk, or uses the recycling kiosk with intent to commit fraud. The video surveillance analysis system may further include a recording device, a monitoring device, or any other fraud detection system or device known to those skilled in the art. The fraud detection system may monitor actions occurring directly in front of the recycling kiosk (i.e., the entity using the recycling kiosk), the general vicinity (i.e., the environment around the recycling kiosk), or the recyclable materials deposited in the recycling kiosk.

In another embodiment of the present invention, a load determining device positioned in the storage container may be utilized with the fraud detection system. The load determining device may measure the weight of the deposited material in a storage container before and after the deposit is made. In this example, a system would be configured to determine the difference between the “after” weight and the “before” weight in the storage container, and compare the measured difference with the recorded weight of the deposited quantity of recyclable material. If the values are exactly or substantially the same, the fraud detection system may perceive that no fraud had occurred with the transaction and the associated user's account may be credited with the calculated reward amount. If the values differ such that the fraud detection system perceived that a fraudulent transaction had occurred, an error code may be encountered and a reward may not be granted.

Alternative embodiments of the present invention may comprise many of the features disclosed herein, however, recycling kiosk may be exemplified in a variety of physical structures. In one exemplary embodiment, a recycling kiosk may be provided in a complete enclosure, for example, within a standard commercial compactor or vending machine structure. In such an embodiment, the features of the recycling kiosk may be formed integrally into the various structures. For example, a recycling kiosk may be formed into a commercial compactor whereby a graphical user interface screen is affixed as a touch-screen LCD monitor on a front side of the compactor, and a lockable storage container having a load determining device built therein may open as a single-hinged rotatable drawer on a side of the compactor. Furthermore, whereas a standard commercial compactor is being modified, and the components of the compactor still exist, a volume reducing compacting device would also be integrally formed within the lockable storage container as discussed above. Other alternative embodiments provide the recycling kiosk may be formed with a vending machine, a video game, or other appropriately sized commercial structure capable of housing the components disclosed herein.

In yet another alternative embodiment, a means for powering the recycling kiosk is provided. In many embodiments, standard AC or DC power, for example, 120V/220V standard wall outlet power may be used to power the recycling kiosk. In other embodiments, to promote the spirit of conserving the environment, the entity using the recycling kiosk may be required to manually pull a level, turn a wheel, etc., to compact the recyclable materials within the storage container. In additional embodiments, power may supplied by charging a capacitor through mechanical energy generated by playing a game (e.g., a foosball table, an air hockey table, and the like), or by using exercising equipment (e.g., a manual treadmill, a stationary bike, and the like).

In certain other embodiments, a recycling kiosk may be provided with sensors or an alarming means for indicating when the storage container of the recycling kiosk is full or substantially full. Such sensors or alarming means may include a volume detection, a weight detection, a manual alert (i.e., would be triggered by an entity using the kiosk), a quantity of use alert (e.g., alerts based on the number of entities, rewards granted, etc., since the last cleanout) or the like. In alternative embodiments, a periodic cleanout schedule may be in place, for example, where a recycling agent or person responsible for the removal of the recyclable materials empties the storage container on a regular periodic basis.

In accordance with one embodiment of the present invention, the recycling kiosk 300 and method of recycling using a recycling kiosk 400 may be handicap accessible and comply with at least one, if not all, of Underwriter Laboratories (UL), Americans with Disability Act (ADA), and/or Federal Communications Commission (FCC) regulations.

It should be emphasized that the above-described embodiments of the present invention, particularly, any listed embodiments, are merely possible examples of implementations, merely set forth for a clear understanding of the principles of the invention. Many variations and modifications may be made to the above-described embodiments) of the invention without departing substantially from the spirit and principles of the invention. All such modifications and variations are intended to be included herein within the scope of this disclosure and the present invention and protected by the following claims.

What is claimed:

1. A method of providing incentive to recycle recyclable materials comprising:
providing a recycling kiosk having a load determining device for receiving a quantity of recyclable materials from at least a first entity;
obtaining identification data associated with the first entity;
measuring the quantity of recyclable material received by the recycling kiosk;
calculating a reward based on a measurement of the quantity of recyclable material disposed at least proximate to the recycling kiosk by the at least one entity; and
associating the reward to the at least one entity.

2. The method of claim 1, wherein measuring the quantity of recyclable material comprises weighing the quantity of recyclable material.

3. The method of claim 1, wherein the recycling kiosk further comprises a recycling storage container.

4. The method of claim 3, further comprising disposing of the quantity of recyclable materials in the recycling storage container.

5. The method of claim 1, further comprising transmitting the identification data associated with the first entity and the reward to a remote database via a computer network.

6. The method of claim 5, wherein the remote database comprises at least one account associated with the first entity.

7. The method of claim 1, wherein obtaining identification data associated with the first entity comprises reading information from at least one of a bar code, magnetic strip, or RFID tag.

8. The method of claim 7, wherein the at least one of a bar code, magnetic strip, or RFID tag are embodied in at least one of a key fob, a recycling container, or a card.

9. The method of claim 1, further comprising providing a fraud detection device proximate the recycling kiosk.

10. The method of claim 9, wherein the fraud detection device comprises at least one of audio-visual surveillance or a lockable recycling storage container.

11. A method of recycling using a recycling kiosk, the method comprising:
providing a recycling kiosk having a load determining device for receiving a quantity of recyclable materials from at least a first entity;
obtaining identification data associated with the first entity;
weighing the quantity of recyclable material received by the recycling kiosk;
transmitting the identification data associated with the first entity and a weight of the quantity of recyclable material to a remote database via a computer network;
calculating a reward based on the weight of the quantity of recyclable material disposed at least proximate to the recycling kiosk by the at least one entity; and
associating the reward to the at least one entity.

12. The method of claim 11, wherein obtaining identification data associated with the first entity comprises reading information from at least one of a bar code, magnetic strip, or RFID tag.

13. The method of claim 12, wherein the at least one of a bar code, magnetic strip, or RFID tag are embodied in at least one of a key fob, a recycling container, or a card.

14. The method of claim 11, further comprising providing a fraud detection device proximate the recycling kiosk.

15. The method of claim 14, wherein the fraud detection device comprises at least one of audio-visual surveillance or a lockable recycling storage container.

16. A recycling kiosk, comprising:
a platform for receiving a quantity of recyclable materials;
a load determining device for measuring the quantity of recyclable materials received on the platform;
a data acquisition unit for obtaining identification data associated with at least a first entity;
a network connection means for connecting to a remote database
a reward calculation means; and
a graphical user interface.

17. The recycling kiosk of claim 14, further comprising a fraud detection device proximate the recycling kiosk.

18. The recycling kiosk of claim 17, wherein the fraud detection device comprises at least one of audio-visual surveillance or a lockable recycling storage container.

19. The recycling kiosk of claim 16, wherein the data acquisition unit comprises at least one of a bar code reader, magnetic strip reader, or RFID tag reader.

20. The recycling kiosk of claim 19, wherein the bar code reader, magnetic strip reader, or RFID tag reader are adapted to read at least one of a key fob, a recycling container, or a card.
